(19) United States
(12) Patent Application Publication
(10) Pub. No.: US 2022/0258639 A1
(43) Pub. Date: Aug. 18, 2022

(54) Methods and Apparatus for Charging Station Identification, Authentication and Energy Delivery

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/724,175

(22) Filed: Apr. 19, 2022

Related U.S. Application Data
(60) Provisional application No. 63/180,179, filed on Apr. 27, 2021.

(51) Int. Cl. B60L 53/65; B60L 53/66; H04W 4/44

(52) U.S. Cl. CPC B60L 53/65; H04W 4/44; B60L 53/665

(57) ABSTRACT

A charging station, an electric vehicle and a server may cooperate to determine whether the charging station and/or the electric vehicle are authentic, so that the charging station may deliver energy to the electric vehicle and the electric vehicle may receive energy from the charging station. The charging station may authenticate the electric vehicle, the electric vehicle may authenticate the charging station or both the charging station and the electric vehicle may mutually authenticate each other. The charging station and the electric vehicle may include local data for authentication without communicating with the server. Energy is not delivered or received without successful authentication.

### FIELD OF THE INVENTION

Embodiments of the present disclosure relate to charging electric vehicles.

### BACKGROUND

Electric vehicles tend to include advanced technology and generally are “connected” devices. The term “connected” means that the vehicles are able to electronically communicate with other electronic devices. An electric vehicle may benefit by using electronic communication to communicate with a charging station prior to charging.

### BRIEF DESCRIPTION OF THE DRAWING

Embodiments of the present invention will be described with reference to the drawing, wherein like designations denote like elements, and:

FIG. 1 is a diagram an example embodiment of a charging facility according to various aspects of the present disclosure;

FIG. 2 is a diagram of an example embodiment of a charging station computer and a power delivery system;

FIG. 3 is a diagram of an example embodiment of an electric vehicle computer;

FIG. 4 is a diagram of an example embodiment of a facility computer;

FIG. 5 is a diagram of an example embodiment of communication performed by a charging station and an electric vehicle;

FIG. 6 is a diagram of an example method for verifying a charging station and delivery of energy to an electric vehicle;

FIG. 7 is a diagram of another example method for verifying a charging station and delivery of energy to an electric vehicle;

FIG. 8 is a diagram of an example method for verifying a charging station, verifying an electric vehicle and delivery of energy to the electric vehicle;

FIG. 9 is a diagram of an example embodiment of a database maintained by a server for verification and/or authentication; and

FIG. 10. is a diagram of an example method for authentication of a charging station, authentication of an electric vehicle and delivery of energy to the electric vehicle.

### DETAILED DESCRIPTION

### Overview

Electric vehicles and charging stations are connected devices in that can communicate with each other and with a server. The electric vehicle and the charging stations may include identifiers that may be sent to the server to determine whether the electric vehicle may receive services from the charging station and whether the charging station may provide services to electric vehicle.

An electric vehicle may request a charging station identifier from a charging station. The electric vehicle may send the charging station identifier to the server. Using the charging station identifier, the server may determine whether the charging station is registered. Determining whether the charging station is registered may also be referred to as determining whether the charging station is authentic, legitimate or authorized. Any method may be used to determine whether the charging station is registered. The method used to determine whether the charging station is registered may also be referred to as authentication or performing an authentication protocol. The server returns a charging station verification notice to the electric vehicle. If the charging station is identified as being registered, the electric vehicle may receive energy from the charging station. If the charging station is identified as being not registered, the electric vehicle provides a notice to the driver the electric vehicle that the electric vehicle should not be charged at that specific charging station.

A charging station may request a vehicle identifier from an electric vehicle. The charging station may send the vehicle identifier to the server. Using the vehicle identifier, the server may determine whether the electric vehicle is registered (e.g., authentic, legitimate, authorized). The server returns a vehicle verification notice to the charging station. If the electric vehicle is identified as being registered, the charging station may provide energy to the electric vehicle. If the electric vehicle is identified as being not registered, the charging station provides a notice to the electric vehicle that it will not provide energy.

The charging station and the electric vehicle may either store information (e.g., authentication data) or receive information (e.g., authentication data, keys) from the server to perform an authentication protocol. The authentication protocol may enable the charging station to authenticate the electric vehicle, the electric vehicle to authenticate the charging station or the charging station and the electric vehicle to authenticate each other.

### Long-Range Communication

A long-range network or long-range communication link refers to a network or long-range link that is capable of communicating (e.g., transmitting, receiving) data (e.g., information) over distances measured in miles or hundreds of miles. A long-range network may include, for example, a cell phone network, a metropolitan area network, a wide area network, a cloud network or any other type of long-range network, including the Internet. A long-range network may be a combination of wired and wireless networks, for example, an electric vehicle may use a wireless communication link to access a wired long-range network. Electric vehicles and/or charging stations may receive information from or provide information to servers via the long-range network. An electric vehicle, a charging station and/or server may communicate via a long-range network using any suitable communication protocol.

### Short-Range Communication

A short-range network or short-range communication link refers to a wireless network or a wireless short-range link that is capable of communicating over distances measured in feet, for example 150 feet. A short-range network may also be referred to as a local network. Short-range network communication protocols include, for example, WiFi, Bluetooth and ZigBee. Although the range of a short-range network may be limited, the throughput (e.g., bit rate) may be high. An electric vehicle and/or a charging station may communicate via a short-range network using any suitable communication protocol. A charging station and an electric vehicle may communicate with each other via short-range broadcast and/or a short-range link.

Long-range and short-range communication protocols may provide secure communication that are resistant to tampering such as man-in-the-middle attacks, eavesdropping and relay attacks.

### Limited-Range Communication

A limit-range network or limited-range communication link refers to a wireless network or a wireless limited-range link that is capable of communicating over much shorter distances, for example 25 feet. Limited-range communication may be accomplished using technologies such as a personal area network (e.g., PAN, Bluetooth piconet network) and/or near-field communication technologies. Near-field communication includes communication between a reader and a tag (e.g., RFID tag). The reader may provide energy to the tag so the tag may operate to transmit its data to the reader. Near-field communication further includes technologies that have a range of up to 10 cm (e.g., key cards, smart cards, near-field tags).

Personal area networks and in particular near-field communication links are limited in range and generally in throughput. Communication via a personal area network or a near-field communication link may be limited to Kilo-bits/second rather than Mega-bits/second or low Mbits/second rather than hundreds of Mbits/second. As used herein, the term limited-range network, limited-range communication or limited-range communication link refers to electronic communication in a range of up to 50 feet, preferably up to about 8 feet, and with a throughput less than 2 Mbits/second, preferably less than 1 Mbits/sec.

Communication Link vs. Broadcasting

As used herein, the term broadcasting refers to transmitting a message (e.g., notice, packet) to all devices at the same time within wireless range or on a network. A device that broadcasts the message does not expect a response or acknowledgment of receipt. The device that broadcasts the message is not aware as to whether other devices are within wireless range or on the network. A device that receives the broadcast, may respond to the device that sent the broadcast by either broadcasting a response or by establishing a link for one-to-one communication with the broadcasting device.

As used herein, the term link or communication link refers to an established pathway for communication between two specific devices. Communications over a link are one-to-one (e.g., between a first device and a second device).

### Charging Station

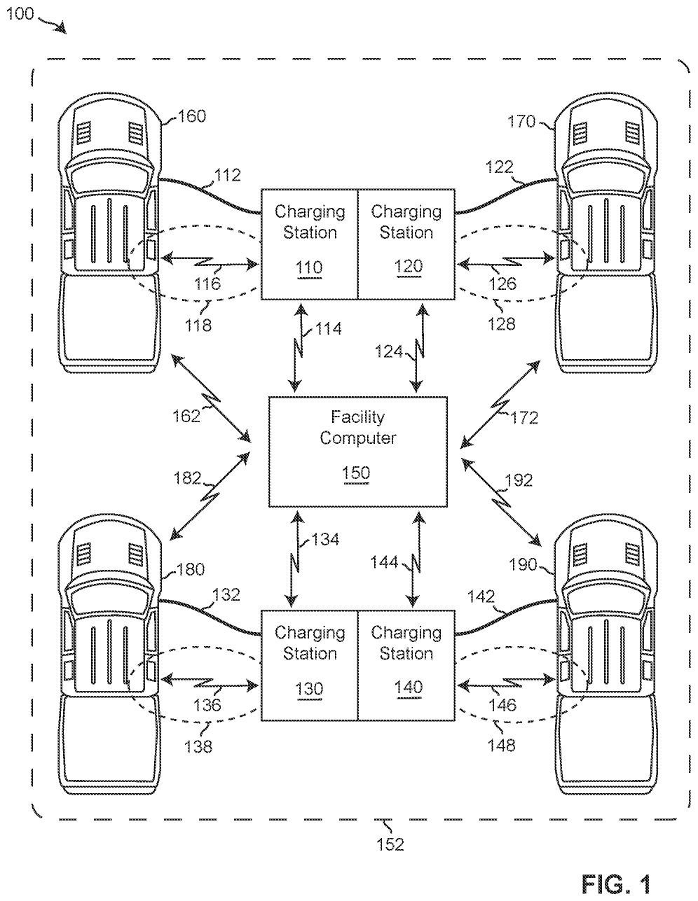

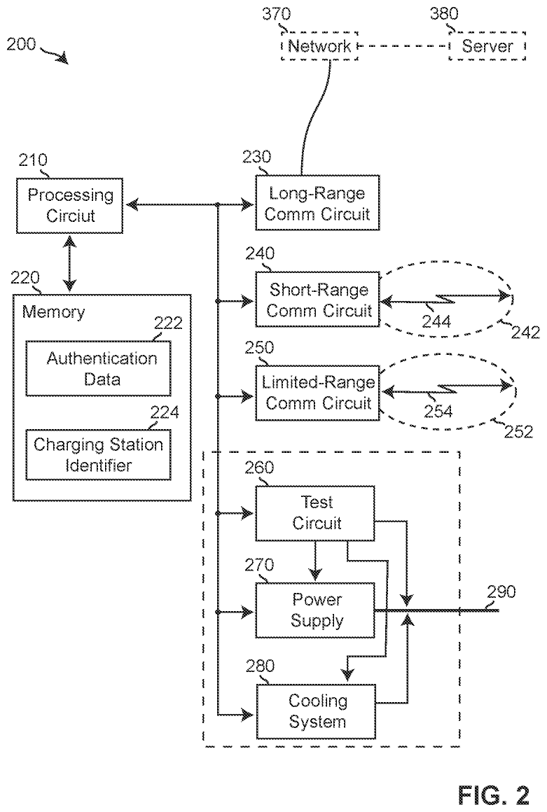

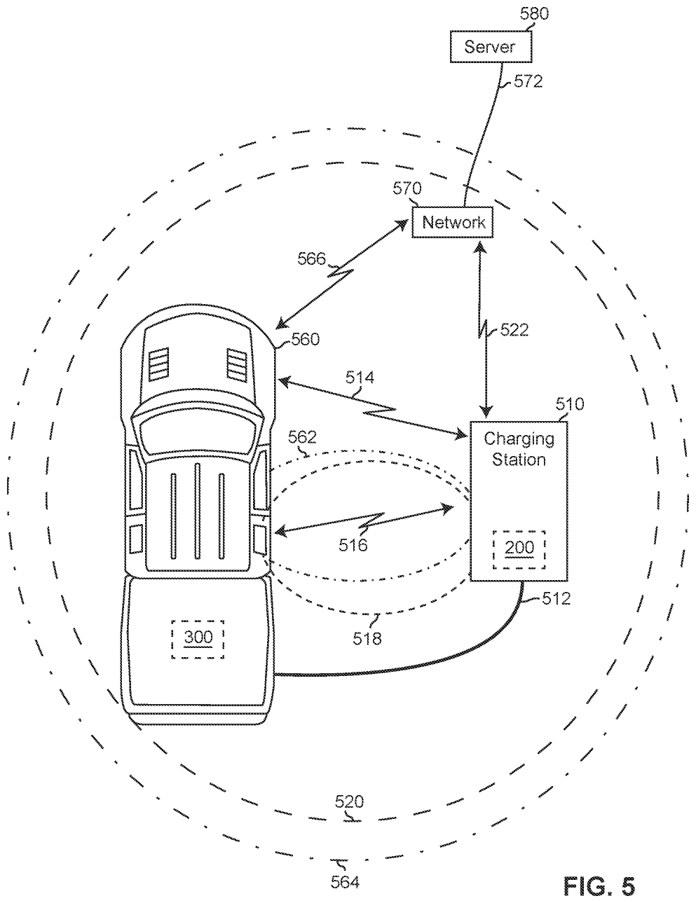

A charging station (e.g., 110, 120, 130, 140, 510), as best shown in FIGS. 1 and 5, is a device that provides energy to an electric vehicle (e.g., 160, 170, 180, 190, 560) to, inter alia, recharge the battery of the electric vehicle. A charging station may provide other functions, such as, providing data for an infotainment system, performing analysis on the systems of the electric vehicle, and detecting faults in the systems of the electric vehicle. A charging station includes systems for providing energy to an electric vehicle, systems for electronic communication, and systems for controlling the operation of the charging station. In an example embodiment, as best shown in FIG. 2, the charging station computer 200 includes a computer and power system. The computer may control in whole or in part the power system. The computer includes a processing circuit 210, a memory 220, a long-range communication circuit 230, a short-range communication circuit 240 and a limited-range communication circuit 250. The power system includes a test circuit 260, a power supply 270, a cooling system 280 and a cable 290.

The processing circuit 210 controls the operations of the charging station. The processing circuit 210 may execute a stored program that instructs the processing circuit 210 as to how to control the operations of the charging station. The processing circuit 210 may control the operation of the power supply 270 to provide energy to the electric vehicle via cable 290. The processing circuit 210 may control the operation of the cooling system 280 as it cools the cable 290 and the operation of the test circuit 260 as it tests (e.g., self-test) the systems (e.g., power supply 270, the cooling system 280, cable 290) of the charging station. Processing circuit 210 may control the long-range communication circuit 230, short-range communication circuit 240 and limited-range communication circuit 250 so the charging station may communicate with other electronic devices, such as electric vehicles and servers (e.g., server 380).

The memory 220 stores data. The memory 220 may provide data to the processing circuit or to any other device via the processing circuit 210. The memory 220 may store such data as authentication data 222 and a charging station identifier 224. The authentication data 222 may be used to authenticate the charging station to electric vehicles and servers. In an example embodiment, the authentication data 222 includes data for authenticating the charging station (e.g., 110, 120, 130, 140, 510) to an electric vehicle (e.g., 160, 170, 180, 190, 560) or to the server 380. In an example embodiment, the authentication data 222 may authenticate the charging station to one or more electric vehicles without receiving information from a server.

The charging station identifier 224 identifies the charging station. In an example embodiment, the charging station identifier 224 uniquely identifies a particular charging station. In another example embodiment, the charging station identifier identifies a group of charging stations. A group of charging stations may have a characteristic in common, such as ownership, charging capability, or other characteristic. The charging station identifier 224 may be used by an electric vehicle to verify that the charging station is registered. In an example embodiment, the charging station identifier 224 includes a serial number, which may be numerical or alphanumerical. The memory 220 may further store the program executed by the processing circuit 210 to perform its functions.

The long-range communication circuit 230 communicates (e.g., transmits, receives) data via a long-range network, such as the network 370. The processing circuit 210 may communicate with the server 380 via the long-range communication circuit 230 and the network 370. In an example embodiment, the long-range communication circuit 230 connects to the network 370 via a wired connection.

The short-range communication circuit 240 communicates via wireless broadcast to devices within range 242, which is the range of the short-range transmitter. The short-range communication circuit 240 may also communicate via wireless link 244 within the range 242.

The limited-range communication circuit 250 communicates via wireless broadcast to devices within range 252, which is the range of the limited-range transmitter. The limited-range communication circuit 250 may also communicate via wireless link 254 within the range 252.

The test circuit 260 includes circuits, firmware and/or hardware (e.g., servo motors, solenoids) for performing tests on the charging station. The tests may be used to determine whether the circuits and/or mechanisms (e.g., mechanical, electromechanical) of the charging station are functioning properly. The test circuit 260 may detect faults in the systems of the charging station or may confirm proper operation of the systems. For example, the test circuit 260 may perform tests on the power supply 270 to determine whether the power supply 270 is operating properly to provide energy to an electric vehicle. The test circuit 260 may perform tests to determine whether the cable 290 is functioning properly to deliver the energy to the electric vehicle. The test circuit 260 may perform tests on the cooling system 280 to determine whether the cooling system 280 is capable of keeping the temperature of the cable 290 at a predetermined value while the charging station provides energy to an electric vehicle. The processing circuit 210 may cooperate with the test circuit 260 to perform the tests, record the results and report the results.

The cooling system 280 maintains the cable 290 at a predetermined temperature while the charging station delivers energy to an electric vehicle. The cooling system 280 may circulate a medium (e.g., liquid, gas) through chambers in the cable 290 to increase or decrease the temperature of the cable 290. Generally, the temperature of the conductor of the cable 290 tends to increase while the power supply 270 delivers energy to the electric vehicle, so the cooling system 280 is used to cool the cable 290. The cable may be transferring hundreds or possibly thousands of amperes of current at any one time.

### Charging Facility

A charging station services a single vehicle at a given time. More than one charging station may be positioned at a location to service a plurality of electric vehicles at the same time. An arrangement of a plurality of charging stations for servicing a plurality of electrical vehicles is referred to herein as a charging facility.

In an example embodiment, as best shown in FIG. 1, a charging facility 100 includes a charging station 110, a charging station 120, a charging station 130, a charging station 140 and a facility computer 150. In this example embodiment, the charging stations 110, 120, 130 and 140 provide charging services to the electric vehicle 160, the electric vehicle 170, the electric vehicle 180 and the electric vehicle 190 at the same time.

The facility computer 150 may be used to control and/or coordinate the operation of the charging stations. For example, the facility computer 150 may control and/or coordinate the communication of the charging stations 110, 120, 130 and 140 with the server 380 via the network 370. The facility computer 150 may further control and/or coordinate the communication between the charging stations and the electric vehicles. For example, the charging station 110 and the electric vehicle 160 may establish wireless short-range links 114 and 162 with the facility computer 150. Communications between the charging station 110 and the electric vehicle 160 may occur via the wireless short-range links 114 and 162 and the facility computer 150. The charging stations 120, 130 and 140 and the electric vehicles 170, 180 and 190 may also establish the wireless short-range links 124, 134, 144, 172, 182 and 192 to similarly communicate. In an example embodiment, the facility computer 150 may perform the function of, inter alia, an access point.

Communication between a charging station and an electric vehicle need not take place via the facility computer 150. Each charging station 110, 120, 130 and 140 may establish a short-range communication link directly with the electric vehicle 160, 170, 180 and 190 respectively. For example, the short-range communication circuit 240 of each charging station 110, 120, 130 and 140 respectively may establish a short-range communication link with the short-range communication circuit 340 of each electric vehicle 160, 170, 180 and 190 respectively. However, if the facility computer 150 establishes a short-range network, the charging stations and electric vehicles may communicate with each other with less interference.

Alternately or in addition to, the charging stations 110 120, 130 and 140 may communicate with the electric vehicles 160, 170, 180 and 190 via wireless limited-range links 116, 126, 136 and 146 and/or through broadcast within limited-range 118, 128, 138 and 148 respectively. Because the limited-range 118, 128, 138 and 148 is limited, the charging stations 110 120, 130 and 140 may communicate directly with the electric vehicles 160, 170, 180 and 190 respectively without interfering other charging stations or electric vehicles. Communication via a limited-range link or broadcast may be used initially to establish short-range links for further communications. For example, a charging station and an electric vehicle may provide each other information via a limited-range link, so that the charging station and the electric vehicle may establish a wireless short-range link.

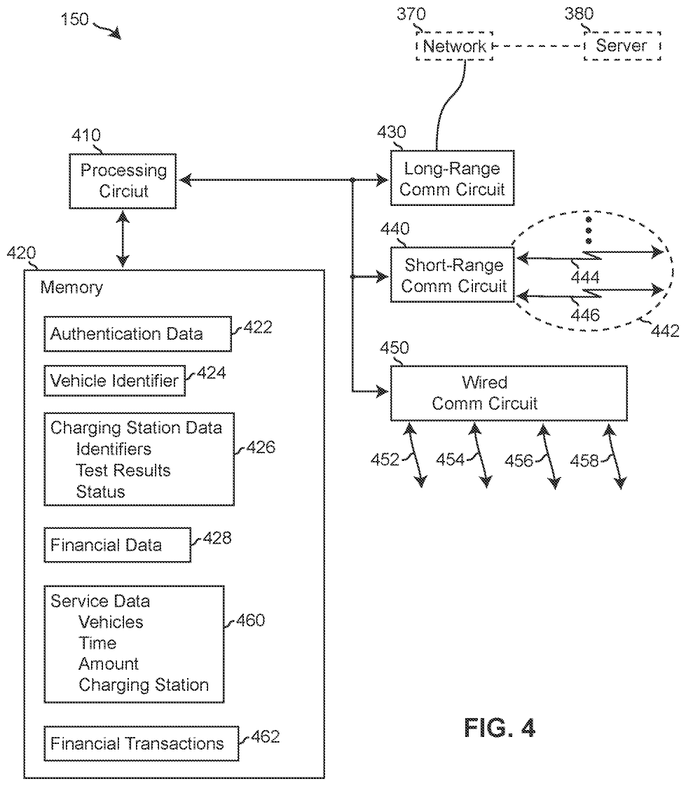

In an example embodiment, as best shown in FIG. 4, the facility computer 150 includes the processing circuit 410, the memory 420, the long-range communication circuit 430, the short-range communication circuit 440 and the wired communication circuit 450. The memory 420 stores data such as authentication data 422, facility identifier 424, charging station data 426, financial data 428, service data 460 and financial transactions 462. The authentication data 422 may include any data needed to authenticate any charging station (e.g., 110, 120, 130, 140) of the charging facility 100 to any electric vehicle (e.g., 160, 170, 180, 190). The facility identifier 424 includes information for identifying the charging facility 100. The facility identifier 424 may include a serial number, which may be numerical or alphanumerical. The facility identifier 424 may further include information as to the number of charging stations that comprise the charging facility 100, power capabilities, delivery capabilities, or other information related to the charging facility.

The charging station data 426 may include the identifiers for the charging stations 110, 120, 130 and 140. The charging station data 426 may further include information regarding self-test results (e.g., test circuit 260) and operating status of the charging stations 110, 120, 130 and 140. The financial data 428 stores financial information related to the charging facility 100. Financial information may include data needed for accepting payment by electric vehicles for services. The service data 460 includes historical record of services provided to electric vehicles. The service data 460 may include the vehicle identifier, the date, the time, the charging station that provided services and the cost related to the services for each electric vehicle serviced at the charging facility 100. The service data 460 may be limited to a particular timeframe, for example six months. The financial transactions 462 may include information related to each financial transaction processed by the charging facility 100 for services provided to an electric vehicle. Information related to financial transactions may include the date, the time, the amount of money, the payor and the financial institution that processed the transaction.

Processing circuit 410 performs and/or coordinates the operation of the charging facility 100. The processing circuit 410 may control and/or coordinate communication between the charging stations and the electric vehicles via short-range communication circuit 440. The short-range communication circuit 440 may establish a plurality of short-range links (e.g., 440, 446, 114, 162, 124, 172, 134, 182, 144, 192) for communication between any vehicle and any charging station. The short-range communication circuit 440 may perform the function of a Wi-Fi access point for communication within range 152. The processing circuit 410 may handle the financial portion of the charging services provided by each charging station 110, 120, 130 and 140.

The processing circuit 210 may control and/or coordinate communication of the charging stations, the vehicles and the charging facility 100 with the server 380 via the long-range communication circuit 430 and the network 370. In an example embodiment, the long-range communication circuit 430 includes a wired connection to the network 370.

In the example embodiment shown in FIG. 1, the charging stations 110, 120, 130 and 140 communicate with the facility computer 150 via the wireless short-range links 114, 124, 134 and 144 respectively. In another example embodiment, the charging stations 110, 120, 130 and 140 have a wired connection 452, 454, 456 and 458 respectively with the facility computer 150 thereby eliminating the wireless short-range links 114, 124, 134 and 144. The wired communication circuit 450 manages the communications via the wired connections 452, 454, 456 and 458.

### Electric Vehicle Computer

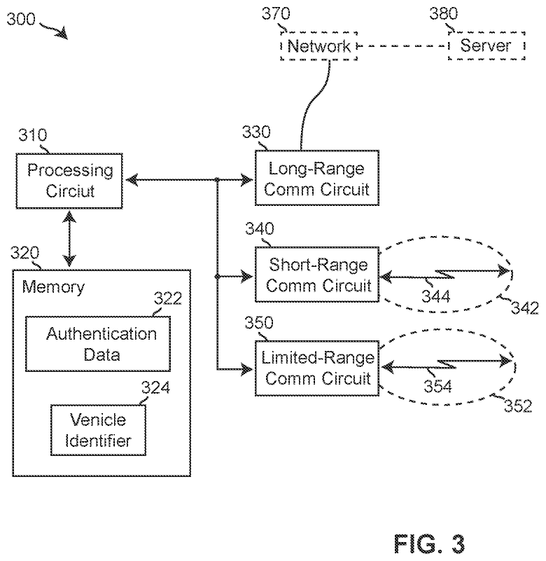

Each electric vehicle (e.g., 160, 170, 180, 190, 560) includes a computer for performing the functions of the electric vehicle, including communication. In an example embodiment, as best shown in FIG. 3, vehicle computer 300 includes a processing circuit 310, a memory 320, a long-range communication circuit 330, a short-range communication circuit 340 and a limited-range communication circuit 350. The vehicle computer 300 of a particular electrical vehicle is mounted to the particular electrical vehicle. The vehicle computer is carried by the electric vehicle as the electric vehicle moves.

The processing circuit 310 controls the operations, at least in part, of the electric vehicle. In the example embodiment shown herein, the processing circuit 310 controls the long-range communication circuit 330, the short-range communication circuit 340 and the limited-range communication circuit 350 to enable the electric vehicle to communicate with the server 380 via the network 370, the charging stations (e.g., 110, 120, 130, 140, 510), and other electric vehicles.

The memory 320 stores data that is accessible to the processing circuit 310 and/or other circuits via processing circuit 310. In an example embodiment, the memory 320 stores authentication data 322 and a vehicle identifier 324. The authentication data 322 may be used to authenticate the electric vehicle to charging stations and servers. In an example embodiment, the authentication data 322 includes data for authenticating the electric vehicle (e.g., 160, 170, 180, 190, 560) to a charging station (e.g., 110, 120, 130, 140, 510) or to the server 380. In an example embodiment, the authentication data 322 may authenticate the electric vehicle to one or more charging stations without receiving information from a server.

The vehicle identifier 324 identifies the electric vehicle. In an example embodiment, the vehicle identifier 324 uniquely identifies a particular electric vehicle. In another example embodiment, the vehicle identifier identifies a group of electric vehicles. A group of electric vehicles may have a characteristic in common, such as ownership, assignment to a fleet, type or other characteristic. The vehicle identifier 324 may be used by a charging station to verify that the electric vehicle is registered. In an example embodiment, the vehicle identifier 324 includes a serial number, which may be numerical or alphanumerical. The memory 220 may further store the program executed by the processing circuit 210 to perform its functions.

The long-range communication circuit 330 communicates (e.g., transmits, receives) data via the network 370. The processing circuit 310 may communicate with the server 380 via the long-range communication circuit 330 and the network 370. In an example embodiment, the long-range communication circuit 330 connects to the network 370 via a wired connection.

The short-range communication circuit 240 communicates via wireless broadcast to devices within range 342, which is the range of the short-range transmitter. The short-range communication circuit 340 may also communicate via wireless link 344 within the range 342.

The limited-range communication circuit 350 communicates via wireless broadcast to devices within range 352, which is the range of the limited-range transmitter. The limited-range communication circuit 350 may also communicate via wireless link 354 within the range 352.

### Single Charging Station

A charging station (e.g., 110, 120, 130, 140) does not need to be part of the charging facility 100 to provide charging services. In an example embodiment, charging station 510 provides charging services to electric vehicle 560. The charging station 510 includes the charging station computer 200 and the electric vehicle 560 includes the vehicle computer 300. The charging station 510 may broadcast data using the limited-range communication circuit 250 within the range 518. The electric vehicle 560 may broadcast data using the limited-range communication circuit 350 within the range 562. If the charging station 510 and the electric vehicle 560 are within the ranges 562 and 518 respectively, then the charging station 510 may receive data from the electric vehicle 560 and the electric vehicle 560 may receive data from the charging station 510.

The charging station 510 and the electric vehicle 560, while in the ranges 518 and 562, may also establish a wireless limited-range link 516 for one-to-one communication. The wireless limited-range link 516 may be used to perform all communication needed for the charging station 510 to provide the electric vehicle 560 with charging services. However, since the bandwidth of the wireless limited-range link 516 is low, the wireless limited-range link 516 may be used for initial communications between the charging station 510 and the electric vehicle 560 to establish the wireless short-range link 514.

The charging station 510 may also broadcast data using the short-range communication circuit 240 within the range 520. The electric vehicle 560 may broadcast data using the short-range communication circuit 340 within the range 564. If the charging station 510 and the electric vehicle 560 are within the ranges 564 and 520 respectively, then the charging station 510 may receive data from the electric vehicle 560 and the electric vehicle 560 may receive data from the charging station 510.

The charging station 510 and the electric vehicle 560, while in the ranges 564 and 520 respectively, may also establish a wireless short-range link 514 for one-to-one communication. The wireless short-range link 514 has high bandwidth and is the preferable link for one-to-one communication between the charging station 510 and the electric vehicle 560, as opposed to the wireless limited-range link 516.

The charging station 510 and/or the electric vehicle 560 may communicate with server 580 via network 570. The charging station 510 may use the long-range communication circuit 230 to communicate with the network 570 and in turn with the server 580. The long-range communication circuit 230 is shown as having a wired connection (refer to FIG. 2) to the network 570. A wired connection between the charging station 510 and the network 570 may be accomplished with a wired cable between the charging station 510 and the network 570. The wired cable between the charging station 510 and the network 570 may be permanently connected. In another example embodiment, the charging station 510 uses the short-range communication circuit 240 to establish a wireless short-range link 522 with the network 570. In this example embodiment, the network 570, or a transceiver thereof, is positioned within the range 520. The network 570, the charging station 510 or the electric vehicle 560 may perform the functions of an access point to establish a short-range network through which the network 570, the charging station 510 and the electric vehicle 560 may communicate. The charging station 510 communicates with the network 570 and thereby with the server 580 via the wireless short-range link 522.

The electric vehicle 560 may use the long-range communication circuit 330 to communicate with the network 570 and in turn with the server 580. The long-range communication circuit 330 is shown as having a wired connection (refer to FIG. 3) to the network 570. A wired connection between electric vehicle 560 and the network 570 may be accomplished by connecting a cable between the electric vehicle 560 and the network 570. The connection would be temporary because after the electric vehicle 560 is charged, it will leave the vicinity of the charging station 510 and the network 570. In another example embodiment, the cable 512 that stretches from the charging station 510 to the electric vehicle 560 may include a cable (not shown) that connects the long-range communication circuit 330 to the network 570 (connection not shown). After charging, the cable 512 is disconnected from the electric vehicle 560, thereby disconnecting the cable from the network 570.

In another example embodiment, the electric vehicle 560 uses the short-range communication circuit 340 to establish a wireless short-range link 566 with the network 570. In this example embodiment, the network 570, or the transceiver thereof, is positioned within the range 564. The electric vehicle 560 communicates with the network 570 and thereby with the server 580 via the wireless short-range link 566.

The charging station 510 and the electric vehicle 560 may exchange any data for the charging station 510 to be able to provide energy to the electric vehicle 560 and for the electric vehicle 560 to receive energy from the charging station 510. Data may include data for authenticating the charging station 510 to the electric vehicle 560 or vice a versa, financial information to pay for the energy provided to the electric vehicle 560, data as to the characteristics of the energy (e.g., voltage, current provided by the charging station 510), information regarding charging such as the amount of charge on the battery, the remaining time to charge the battery, and/or the temperature of the battery.

Data may be communicated between the charging station 510 and electric vehicle 560 using any communication protocol. Data may be retransmitted when not received. Receipt of data may be acknowledged. Different communication links (e.g., 514, 516, 522, 566) may use different protocols.

### Methods for Verification and Charging

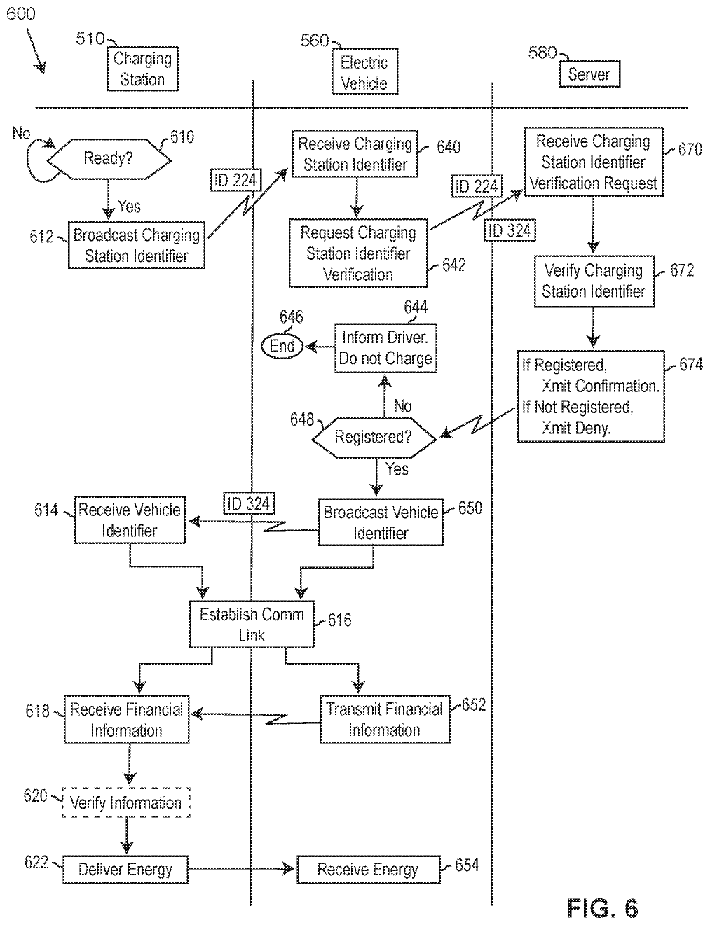

Example embodiments of methods for charging an electric vehicle are shown in FIGS. 6-8 and 10. The methods are described with respect to charging station 510, electric vehicle 560 and server 580; however, the same methods may be used with respect to any charging station (e.g., 110, 120, 130, 140) of the charging facility 100 and any electric vehicle (e.g., 160, 170, 180, 190). If the methods are performed by the charging facility 100, the method may be controlled by the facility computer 150. Further, any method may be performed for any charging station-electric vehicle pair of the charging the facility 100 at the same time.

Example Method 600

In an example embodiment, method 600, as best seen in FIG. 6, the electric vehicle 560 verifies that the charging station 510 is registered (e.g., authorized, legitimate, authentic), so the electric vehicle 560 may receive energy from the charging station 510. The method 600 includes various operations that are performed by the charging station 510, the electric vehicle 560 and the server 580. The charging station 510, the electric vehicle 560 and the server 580 may communicate with each other to perform their various operations. Broadcast may occur within the range 518, 520, 562 and 564. Communication may occur via the wireless short-range links 514, 522 and 566 and/or the wireless limited-range link 516. The range or link used for communication is not shown in FIG. 6. Energy is provided by the charging station 510 to the electric vehicle 560 via the cable 512, so the cable 512 should be electrically connected to the electric vehicle 560 prior to energy delivery.

In the example the method 600, the charging station 510 performs the operations ready 610, broadcast 612, receive 614, establish 616, receive 618 and deliver 622. The charging station 510 may optionally perform verify 620. The electric vehicle 560 performs the operations receive 640, request 642, inform 644, end 646, registered 648, broadcast 650, establish 616, transmit 652 and receive 654. The server 580 performs the operations receive 670, verify 672 and if 674.

The performance of one operation may depend on the performance of one or more other operations. The sequence in which the charging station 510, the electric vehicle 560 and the server 580 perform their respective operations is shown in FIG. 6, so the flow of execution may not be explicitly described below. Each operation that is performed responsive to receiving a communication or data, may include a timeout, so that if the communication or data is not received, execution of the operation is halted and control is returned to either a recovery state or beginning state. Timeouts in the response to not receiving a communication or data are not shown. Further, failsafe code executed in the event of an unexpected situation or failure is not shown to improve the clarity of the diagram.

In ready 610, the charging station 510 determines that it is ready to begin the process of delivering energy to an electric vehicle. The charging station 510 may determine that it is ready to deliver energy by performing one or more self-tests. Successful completion of the one or more self-tests indicates that the charging station 510 is ready and able to deliver energy. When the charging station 510 determines that it is ready, execution for the processing circuit 210 moves to broadcast 612.

In broadcast 612, the processing circuit 210 broadcasts the charging station identifier 224. The processing circuit 210 may broadcast the charging station identifier 224 using the limited-range communication circuit 250 to broadcast within the range 518 and/or the short-range communication circuit 240 to broadcast within the range 520. The processing circuit 210 may broadcast the charging station identifier 224 one or more times. Broadcasts of the charging station identifier 224 may be periodic until a response is received. The processing circuit 210 may receive a response (e.g., acknowledgment) from an electric vehicle positioned within the range 518 or 520. Upon receiving an acknowledgment, execution the processing circuit 210 may move to receive 614 to wait for a vehicle identifier. In another example embodiment, the processing circuit 210 continues to execute broadcast 612 and moves to receive 614 upon receiving the vehicle identifier 324.

In receive 640, the electric vehicle 560 receives the charging station identifier 224. Receive 640 may include transmitting an acknowledgment of receipt and/or requesting a retransmission. Execution for the processing circuit 310 moves to request 642.

In request 642, the processing circuit 310 uses the short-range communication circuit 340 to transmit a verification request to the server 580. The processing circuit 310 may transmit the verification request using the short-range communication circuit 340 via the wireless short-range link 566. In another example embodiment, the processing circuit 310 transmits the verification request via the wireless short-range link 514 and, with the cooperation of the processing circuit 210, via the wireless short-range link 522. In another example embodiment, the processing circuit 310 uses the long-range communication circuit 330 to transmit the verification request via a wired connection (not shown) to the network 570. The verification request includes the charging station identifier 224 so that the server 580 may verify that the charging station 510 is authorized to provide energy to the electric vehicle 560. The verification request may further include the vehicle identifier 324, so the server 580 knows which electric vehicle is requesting the verification. The vehicle identifier 324 may also be used to determine whether the electric vehicle 560 is authorized to receive energy from the charging station 510.

In receive 670, the server 580 receives the verification request.

In verify 672, the server 580 uses the charging station identifier 224 and possibly the vehicle identifier 324 to verify whether the charging station 510 is authorized to provide energy to the electric vehicle 560. The server will also determine whether the electric vehicle 560 is authorized to receive energy from the charging station 510.

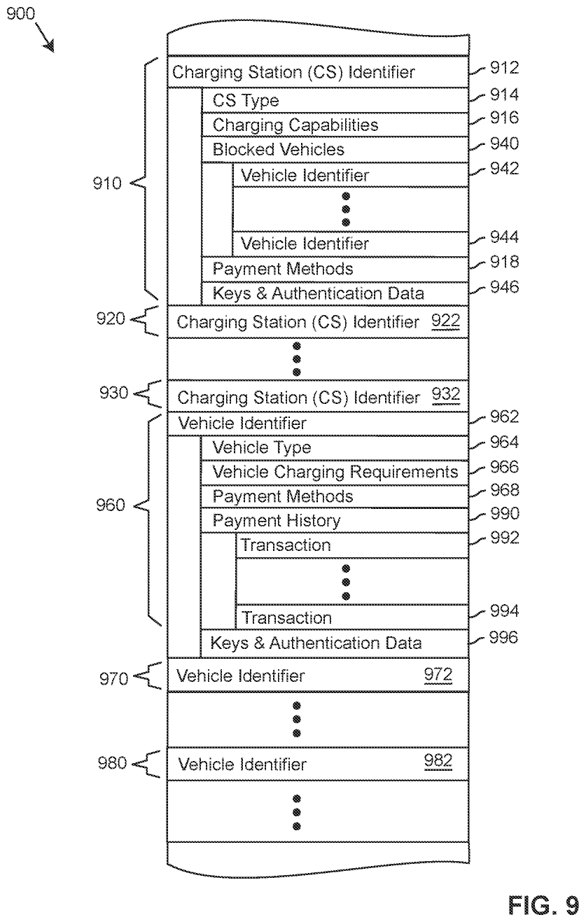

Verification may be accomplished in any manner. In an example embodiment, the verification uses authentication techniques to authenticate the charging station 510, or the charging station 510 and the electric vehicle 560. In an example embodiment, the server maintains database 900, as best seen in FIG. 9. Database 900 stores data for verification. In the example embodiment of database 900, information is stored as records that relate to a charging station identifier or a vehicle identifier. For example, record 910 stores information related to the charging station that has charging station identifier 912. Records 920 and 930 store information related to the charging stations that have charging station identifiers 922 and 932 respectively. Each record relates to a single charging station. The records 910, 920 and 930 are indexed in the database 900 by their respective charging station identifiers.

In database 900, information is also stored as records that relate to a vehicle identifier. For example, record 960 stores information related to the electric vehicle that has the vehicle identifier 962. Records 970 and 980 store information related to the electric vehicles that have vehicle identifiers 972 and 982 respectively. Each record relates to a single electric vehicle. The records 960, 970 and 980 are indexed in the database 900 by their respective vehicle identifiers.

In one example embodiment, as part of verify 672, the server 580 may use the charging station identifier 224 to access keys and/or authentication data 946. The server 580 may use the keys and/or authentication data 946 to perform an authentication process with the charging station 510 to determine whether the charging station 510 is authentic (e.g., legitimate). In another example embodiment, as part of verify 672, the server 580 may use the charging station identifier 224 and the vehicle identifier 324 to access keys and/or authentication data 946 and keys and/or authentication data 996 to perform an authentication process with the charging station 510 and electric vehicle 560 to determine whether they are both authentic. In another example embodiment, as part of verify 672, the server 580 may access the database 900 to determine whether a charging station record (e.g., 910, 920, 930) exists for the charging station identifier. If a record exists, the charging station 510 has been verified and is authentic. In another example embodiment, as part of verify 672, the server 580 may access the charging station type 914 and/or the charging capabilities 916 of the charging station 510 and vehicle type 964 and/or vehicle charging requirements 966 of the electric vehicle 560 to determine whether the charging station 510 is functionally able (e.g., compatible with) to provide energy to the electric vehicle 560.

The record (e.g., 910, 920, 930) for a charging station may include a list of vehicles 940-944 that for some reason have been identified (e.g., flagged, tagged) as blocked so that the charging station will not provide energy to the blocked electric vehicles. The record for a charging station further identifies the payment methods 918 that the charging station 510 is able to use to receive payment for the energy. The record for an electric vehicle further includes payment methods 968 as to methods available to the electric vehicle to make payment. The server 580 may use the information it stores in the records for the charging station identifier 224 and the record it stores for the vehicle identifier 324 in any manner to verify whether the charging station 510 should provide energy to the electric vehicle 560 or if the electric vehicle 560 should receive energy from the charging station 510.

In if 674, the server 580 sends the results of verify 672 to the electric vehicle 560. If the results of verify 672 is that the charging station 510 is registered (e.g., authentic, legitimate, verified), the server 580 transmits a charging station verification notice to the electric vehicle 560 that informs the electric vehicle 560 that the charging station 510 is registered. If charging station 510 is registered, the electric vehicle 560 may receive energy from the charging station 510. If the results of verify 672 is that the charging station 510 is not registered, the server 580 transmits the charging station verification notice to the electric vehicle 560 that informs electric vehicle 560 that the charging station 510 is not registered. If the charging station 510 is not registered, the electric vehicle 560 should not receive energy from the charging station 510.

In registered 648, the electric vehicle 560 receives the charging station verification notice from the server 580. In registered 648, the processing circuit 310 decodes the charging station verification notice to determine whether the charging station 510 is registered or is not registered. In the event that the charging station 510 is not registered, execution for the processing circuit 310 moves to inform 644. In the event that the charging station 510 is registered, execution for the processing circuit 310 moves to broadcast 650.

In inform 644, the processing circuit 310 informs the driver that they should not charge at charging station 510. The processing circuit 310 may inform the driver in any manner. In an example embodiment, the processing circuit 310 sends a text message to the phone of the driver using the short-range communication circuit 340. In another example embodiment, the processing circuit 310 presents information on a display (not shown) in the electric vehicle 560 for the driver to read. Execution for the processing circuit 310 moves to end 646.

In end 646, the processing circuit 310 ends execution of its portion of the method 600.

In broadcast 650, the electric vehicle 560 has been authorized to receive energy from the charging station 510. In broadcast 650, the processing circuit 310 sends the vehicle identifier 324 to the charging station 510.

In receive 614, the charging station 510 receives the vehicle identifier 324. The charging station 510 may use the vehicle identifier 324 for any purpose. For example, in an example embodiment, and at a later stage in the method 600, the processing circuit 210 may execute verify 620. In an example embodiment, verify 620 communicates with the server 580 to determine whether the financial information provided by the electric vehicle 560 is legitimate. Determining whether the financial information is legitimate may include determining whether the electric vehicle 560 is registered. In another example embodiment, verify 620 communicates with server 580 to determine whether the electric vehicle 560 is registered. Verify 620 may include operations that are similar to request 642, registered 648, inform 644, and end 646.

In establish 616, the charging station 510 and the electric vehicle 560 establish a wireless link for one-to-one communication. In an example embodiment, the wireless limited-range link 516 is established. In another example embodiment, the wireless short-range link 514 is established. Preferably, the charging station 510 and the electric vehicle 560 establish the wireless short-range link 514 because it provides greater range and higher bandwidth. After execution of establish 616, the charging station 510 and the electric vehicle 560 communicate with each other via the wireless link that has been established.

In transmit 652, the electric vehicle 560 transmits financial information to the charging station 510 that the charging station 510 may use to receive payment for the energy provided. The charging station 510 may provide the financial information to the server 580 to collect payment.

In receive 618, the charging station 510 receives the financial information transmitted by the electric vehicle 560. Execution moves to verify 620, if included in the method 600, or otherwise to deliver 622.

In deliver 622 the charging station 510 delivers energy to the electric vehicle 560. The energy is delivered via the cable 512. The energy is delivered with the characteristics (e.g., voltage, current) required by the electric vehicle 560. In receive 654, the electric vehicle 560 receives the energy provided by the charging station 510 via the cable 512. The operations deliver 622 and receive 654 may include communication between the charging station 510 and the electric vehicle 560 that affects the delivery and receipt of the energy. For example, the electric vehicle 560 may request that the energy be delivered at a different voltage or with a different current profile. The charging station 510 may request the percent of charge on the battery or the temperature of the battery. The electric vehicle 560 may monitor the temperature of the connection between the electric cable and the electric vehicle 560. The temperature may be reported to the charging station 510. The charging station 510 may adjust the cooling system 280 responsive to the reported temperature. The charging station 510 and the electric vehicle 560 may independently measure the characteristics of the energy being provided and report to each other the measured characteristics.

The operations deliver 622 and receive 654 are performed until the battery of the electric vehicle 560 is 100% charged, until the charging station 510 can no longer provide energy, until the electric vehicle 560 requests the termination of charging, or until a dollar amount of provided energy is reached.

Example Method 700

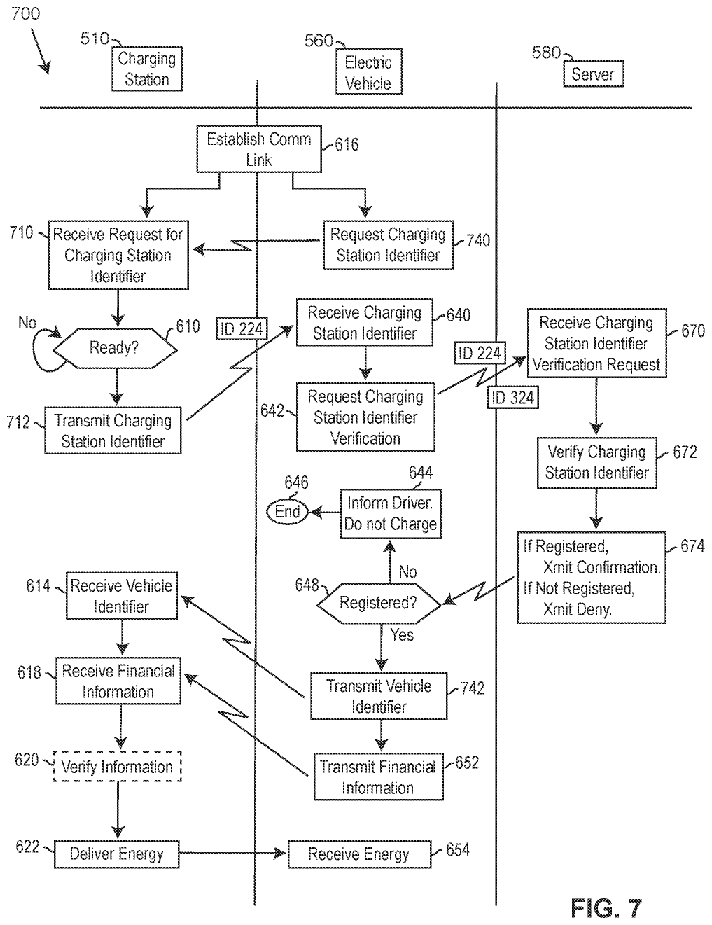

In another example method, method 700, as best seen in FIG. 7, the electric vehicle 560 verifies that the charging station 510 is registered (e.g., authorized, legitimate, authentic), so the electric vehicle 560 may receive energy from the charging station 510. The method 700 includes various operations that are performed by the charging station 510, the electric vehicle 560 and the server 580. The charging station 510, the electric vehicle 560 and the server 580 may communicate with each other to perform their various operations. Broadcast may occur within the range 518, 520, 562 and 564. Communication may occur via the wireless short-range links 514, 522 and 566 and/or the wireless limited-range link 516. The range or link used for communication is not shown in FIG. 7. Energy is provided by the charging station 510 to the electric vehicle 560 via the cable 512, so the cable 512 should be electrically connected to the electric vehicle 560 prior to energy delivery.

In an example method 700, the charging station 510 performs the operations establish 616, receive 710, ready 610, transmit 712, receive 614, receive 618 and deliver 622. The charging station 510 may optionally perform verify 620. The electric vehicle 560 performs the operations establish 616, request 740, receive 640, request 642, informed 644, end 646, registered 648, transmit 742, transmit 652 and receive 654. The server 580 performs the operations receive 670, verify 672 and if 674. Many the individual operations that are included in the method 700 are the same as those that are in the method 600, the possibly used in a different sequence.

As with the method 600, the performance of one operation may depend on the performance of one or more other operations. The sequence in which the charging station 510, the electric vehicle 560 and the server 580 perform their respective operations is shown in FIG. 7, so the flow of execution may not be explicitly described below. Each operation that is performed responsive to receiving a communication or data, may include a timeout, so that if the communication or data is not received, execution of the operation is halted and control is returned to either a recovery state or beginning state. Timeouts in the response to not receiving a communication or data are not shown. Further, failsafe code executed in the event of an unexpected situation or failure is not shown to improve the clarity of the diagram.

In establish 616, discussed above, the charging station 510 and the electric vehicle 560 establish a wireless link for one-to-one communication. In this example method, the wireless link is either the wireless limited-range link 516 or the wireless short-range link 514. It is conceivable that both the wireless short-range link 514 and the wireless limited-range link 516 could be established and used for communication; however, the wireless short-range link 514 is a high-bandwidth link and is preferable over the wireless limited-range link 516. In an example embodiment, the wireless limited-range link 516 may be established first and used to establish the wireless short-range link 514. Execution for the charging station 510 moves to receive 710. Execution for the electric vehicle 560 moves to request 740.

In request 740, the electric vehicle 560 requests that the charging station 510 provide its charging station identifier 224. The request is transmitted by the electric vehicle 560 to the charging station 510 via the wireless link established in establish 616.

In receive 710, the charging station 510 receives the request for the charging station identifier 224. Receive 710 may retrieve the charging station identifier 224 from the memory 220.

Ready 610 is discussed above. When the charging station 510 determines that it is ready, execution moves to transmit 712.

In transmit 712, the charging station 510 transmits the charging station identifier 224 to the electric vehicle 560. The charging station identifier 224 is transmitted via the link established in establish 616.

Receive 640 and request 642 are discussed above. The request, the charging station identifier 224 and possibly the vehicle identifier 324 are transmitted to the server 580 via the wireless short-range link 566.

Receive 640, verify 672 and if 674 are discussed above.

Registered 648 is discussed above. If the charging station verification notice received by registered 648 indicates that the charging station 510 is not registered, execution moves to inform 644 and end 646 both of which are discussed above. If the charging station verification notice received by registered 648 indicates that the charging station is registered, execution moves to transmit 742.

In transmit 742, the electric vehicle 560 transmits its vehicle identifier 324 to the charging station 510. The vehicle identifier 324 is transmitted via the link established in establish 616. Transmit 742 may retrieve the vehicle identifier 324 from the memory 320.

Receive 614, transmit 652 and receive 618 are discussed above. If optional operation verify 620 is to be executed, its execution follows the execution of receive 618, as discussed above.

Deliver 622 and receive 654 are discussed above.

Example Method 800

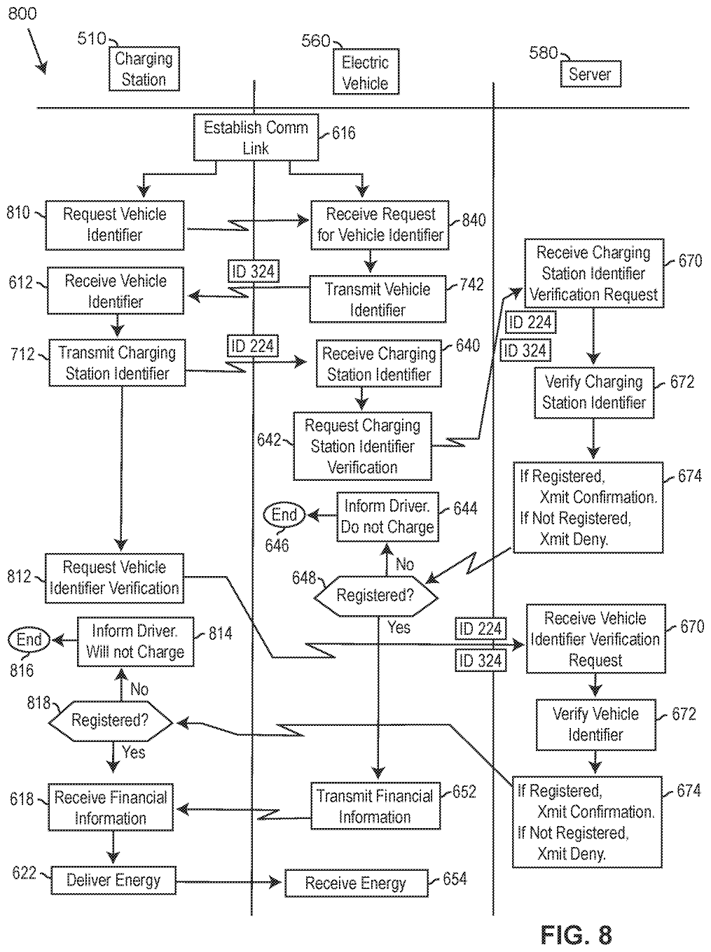

In another example method, method 800, as best seen in FIG. 8, the electric vehicle 560 verifies that the charging station 510 is registered (e.g., authorized, legitimate) and the charging station 510 verifies that the electric vehicle 560 is also registered prior to receiving and providing respectively energy. The method 800 includes various operations that are performed by the charging station 510, the electric vehicle 560 and the server 580. The charging station 510, the electric vehicle 560 and the server 580 may communicate with each other to perform their various operations. Broadcast may occur within the range 518, 520, 562 and 564. Communication may occur via the wireless short-range links 514, 522 and 566 and/or the wireless limited-range link 516. The range or link used for communication is not shown in FIG. 8. Energy is provided by the charging station 510 to the electric vehicle 560 via the cable 512, so the cable 512 should be electrically connected to the electric vehicle 560 prior to energy delivery.

In the example method 800, the charging station 510 performs the operations establish 616, request 810, receive 614, transmit 712, request 812, inform 814, end 816, registered 818, receive 618 and a deliver 622. The electric vehicle 560 performs the operations establish 616, receive 840, transmit 742, receive 640, request 642, inform 644, end 646, registered 648, transmit 652 and receive 654. The server 580 performs the operations receive 670, verify 672 and if 674, receive 870 and verify 872. Many the operations that are included in method 800 are the same as those that are in the methods 600 and 700.

As with the methods 600 and 700, the performance of one operation may depend on the performance of one or more other operations. The sequence in which the charging station 510, the electric vehicle 560 and the server 580 perform their respective operations is shown in FIG. 8, so the flow of execution may not be explicitly described below. Each operation that is performed responsive to receiving a communication or data, may include a timeout, so that if the communication or data is not received, execution of the operation is halted and control is returned to either a recovery state or beginning state. Timeouts in the response to not receiving a communication or data are not shown. Further, failsafe code executed in the event of an unexpected situation or failure is not shown to improve the clarity of the diagram.

In establish 616, discussed above, the charging station 510 and the electric vehicle 560 establish a wireless link for one-to-one communication.

In request 810, the charging station 510 requests that the electric vehicle 560 provide its vehicle identifier 324. The request is transmitted by the charging station 510 to the electric vehicle 560 via the wireless link established in establish 616.

In receive 840, the electric vehicle 560 receives the request for the vehicle identifier 324. Receive 840 may retrieve the vehicle identifier 324 from the memory 320.

Transmit 742, receive 614, transmit 712, receive 640 and request 642 are discussed above. The request, the charging station identifier 224 and possibly the vehicle identifier 324 are transmitted to the server 580 via the wireless short-range range link 566.

The operations receive 670, verify 672 and if 674, each discussed above, are executed by the server 580 responsive to the server 580 receiving charging station identifier 224 from the electric vehicle 560. Responsive to the charging station identifier 224, the server 580 transmits a charging station verification notice to the electric vehicle 560 regarding the registration of the charging station 510. The electric vehicle 560 receives the notice from the server 580 in registered 648. The operations registered 648, inform 644 and end 646 are discussed above. As discussed above, inform 644 and end 646 are executed in response to a charging station verification notice that informs electric vehicle 560 that the charging station 510 is not registered. In the event that the charging station verification notice informs electric vehicle 560 that the charging station 510 is registered, execution moves to transmit 652.

In request 812, the processing circuit 210 of the charging station 510 transmits a verification request to the server 580. The verification request includes the vehicle identifier 324 of the electric vehicle 560. The request may further include the charging station identifier 224 of the charging station 510.

In receive 870, the server 580 receives the verification request.

Verify 872 is similar to verify 672 except that the authenticity of electric vehicle 560 is verified rather than the authenticity of the charging station 510. The methods and techniques used by the server 580 to verify the electric vehicle 560 are analogous to the methods and techniques used by the server 580 to verify the charging station 510.

In verify 872, the server 580 uses the vehicle identifier 324, and possibly the charging station identifier 224, to verify whether the electric vehicle 560 is authorized to receive energy from the charging station 510. As discussed above with respect to verify 672, verify 872 may accomplish verification in any manner. Any information in database 900 may be used to verify that the electric vehicle 560 is authorized to receive energy from the charging station 510.

In one example embodiment, as part of verify 872, the server 580 may use the vehicle identifier 324 to access keys and/or authentication data 996. The server 580 may use the keys and/or authentication data 996 to perform an authentication process with the electric vehicle 560 to determine whether the electric vehicle 560 is authentic (e.g., legitimate, registered). In another example embodiment, as part of verify 872, the server 580 may use the charging station identifier 224 and vehicle identifier 324 to access keys and/or authentication data 946 to perform an authentication process with the charging station 510 and electric vehicle 560 to determine whether they are authentic. In another example embodiment, as part of verify 872, the server 580 may access the database 900 to determine whether an electric vehicle record (e.g., 960, 970, 980) exists for the electric vehicle 560. If a record exists, the electric vehicle 560 has been verified as being registered and is authentic.

In another example embodiment, discussed above with respect to verify 672, the server 580 may access, as part of verify 872, the charging station type 914, the charging capabilities 916, the vehicle type 964, and/or the vehicle charging requirements 966 to determine whether the electric vehicle 560 is functionally able (e.g., compatible with) to receive energy from the charging station 510. In another example embodiment, the server 580 may access, as part of verify 872, payment methods 918 and payment methods 968 to determine whether the payment methods of the charging station 510 are compatible with the payment methods of the electric vehicle 560 respectively. If the payment methods are incompatible, the electric vehicle 560 will not be able to pay the charging station 510 for its services, so the charging station 510 should decline to deliver energy to the electric vehicle 560.

The record for an electric vehicle (e.g., 960, 970, 980) may include payment history 990 which includes a list of recent transactions 992 to 994. The server 580 may search a list of recent transactions to determine whether the electric vehicle 560 has recently had a transaction with the charging station 510. This search may provide additional information with respect to authenticating the electric vehicle 560.

Registered 818 receives the vehicle verification notice from the server 580 with respect to verifying the electric vehicle 560. In registered 818, the processing circuit 210 decodes the vehicle verification notice to determine whether the electric vehicle 560 is registered or not registered. In the event that the electric vehicle 560 is not registered, execution moves to inform 644. In the event that the electric vehicle 560 is registered, execution moves to receive 618.

In inform 814, the processing circuit 210 informs the driver of the electric vehicle 560 that it will not provide energy to the electric vehicle 560. The processing circuit 210 may inform the driver in any manner. In an example embodiment, the processing circuit 210 sends a message to the electric vehicle 560 via the wireless link established in establish 616. The electric vehicle 560 presents a message on a display for the driver to read informing the driver that the charging station 510 will not provide energy. Execution moves to end 816.

In end 646, the processing circuit 210 ends execution of its portion of the method 600.

In the event that the verification notice informs the charging station 510 that the electric vehicle 560 is registered, execution by the charging station 510 moves from registered 818 to receive 618. Transmit 652, executed by the electric vehicle 560, and receive 618 are discussed above. Also discussed above are deliver 622 and receive 654.

Example Method 1000

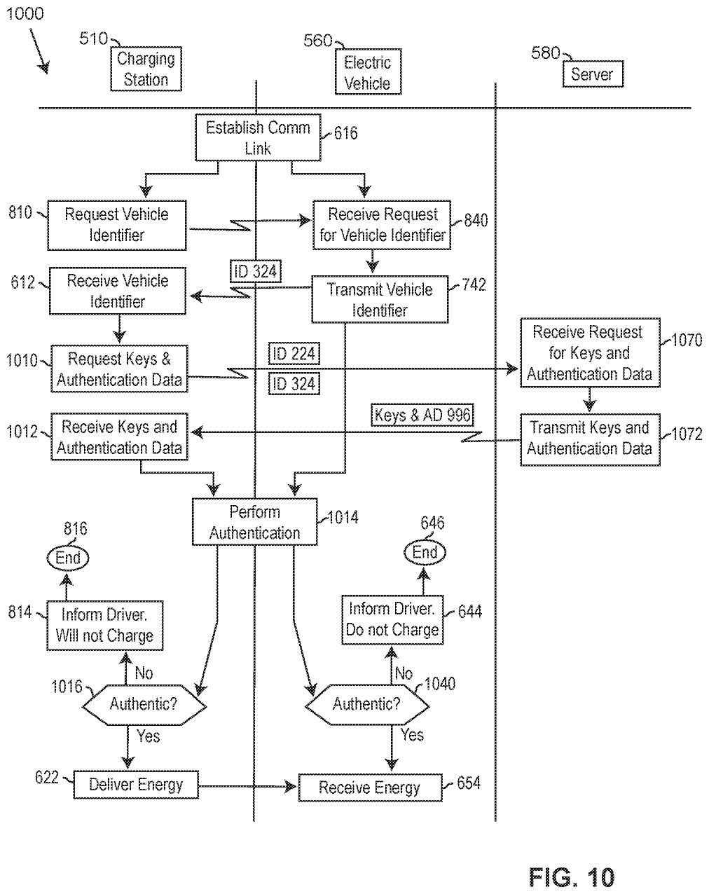

In an example embodiment, method 1000, as best seen in FIG. 10, the charging station 510 receives keys and/or authentication data 996 (e.g., information) from the server 580. The charging station 510 uses keys and/or authentication data 996 to authenticate the electric vehicle 560. If the authentication process determines that the electric vehicle 560 is not authentic, the charging station 510 does not deliver energy to the electric vehicle 560. If the authentication process determines that the electric vehicle 560 is authentic, then the charging station 510 delivers energy to the electric vehicle 560.

The authentication process may include any technique for authenticating. The information (e.g., keys and authentication data) received from the server 580 may include any type of information useful for authentication. The information from the server 580 may be used in any manner to perform authentication.

In another example embodiment of a method, the electric vehicle 560 receives keys and/or authentication data 946 from the server 580. The electric vehicle 560 uses the keys and/or authentication data 946 to authenticate the charging station 510. If the authentication process determines that the charging station 510 is not authentic, the electric vehicle 560 does not receive energy from the charging station 510. If the authentication process determines that the charging station 510 is authentic, then the electric vehicle 560 receives energy from the charging station 510.

In another example embodiment of a method, the charging station 510 receives keys and/or authentication data 996 and electric vehicle 560 receives keys and/or authentication data 946 from the server 580. The charging station 510 and the electric vehicle 560 use the keys and/or authentication data 996 and 946 to authenticate each other. If either the charging station 510 or the electric vehicle 560 determines that the other is not authentic, then energy is not delivered and/or energy is not received. If both the charging station 510 and the electric vehicle 560 determined that each other is authentic, then energy is delivered and energy is received.

As with the previously discussed methods, the method 1000 includes various operations that are performed by the charging station 510, the electric vehicle 560 and the server 580. The charging station 510, the electric vehicle 560 and the server 580 may communicate with each other to perform their various operations. Broadcast may occur within the range 518, 520, 562 and 564. Communication may occur via the wireless short-range links 514, 522 and 566 and/or the wireless limited-range link 516. The range or link used for communication is not shown in FIG. 10. Energy is provided by the charging station 510 to the electric vehicle 560 via the cable 512, so the cable 512 should be electrically connected to the electric vehicle 560 prior to energy delivery.

In an example method 1000, the charging station 510 performs the operations establish 616, request 810, receive 614, request 1010, receive 1012, perform 1014, authentic 1016, inform 814, end 816 and deliver 622. The electric vehicle 560 performs the operations establish 616, receive 840, transmit 742, perform 1014, authentic 1040, inform 644, end 646 and receive 654. The server 580 performs the operations receive 1070 and transmit 1072.

The performance of one operation may depend on the performance of one or more other operations. The sequence in which the charging station 510, the electric vehicle 560 and the server 580 perform their respective operations is shown in FIG. 10, so the flow of execution may not be explicitly described below. Each operation that is performed responsive to receiving a communication or data, may include a timeout, so that if the communication or data is not received, execution of the operation is halted and control is returned to either a recovery state or beginning state. Timeouts in the response to not receiving a communication or data are not shown. Further, failsafe code executed in the event of an unexpected situation or failure is not shown to improve the clarity of the diagram.

The operations establish 616, request 810, receive 840, receive 614, transmit 742, inform 814, end 816, inform 644, end 646, deliver 622 and receive 654 are discussed above.

In request 1010, the charging station 510 sends a request to the server 580 for the keys and/or authentication data 996 associated with the electric vehicle 560. The request includes the vehicle identifier 324 for the electric vehicle 560. The request may further include the charging station identifier 224.

In receive 1070, the server 580 receives the vehicle identifier 324 from the charging station 510. Receive 1070 accesses the database 900 finds the vehicle record (e.g., 960, 970, 980) associated with the vehicle identifier 324 and retrieves the keys and/or authentication data 996. The keys and/or authentication data 996 retrieved pertain to the electric vehicle 560. The keys and/or authentication data 996 may uniquely pertain to the electric vehicle 560.

In transmit 1072, the server 580 transmits the keys and/or authentication data 996 to the charging station 510.

In receive 1012, the charging station 510 receives the keys and/or authentication data 996 for the electric vehicle 560.

In perform 1014, the charging station 510 and the electric vehicle 560 perform an authentication protocol to enable the charging station 510 to determined that the electric vehicle 560 is authentic (e.g., approved, registered). The charging station 510 may use the keys and/or authentication data 996 to enable authentication of the electric vehicle 560. Authentication enables the charging station 510 to determine that it is authorized to provide energy to the electric vehicle 560 and/or that the electric vehicle 560 is authorized to receive energy from the charging station 510. Further, the authentication protocol definitively identifies the electric vehicle 560 to the charging station 510. The result of the authentication protocol is reported to at least the charging station 510; however, in this example method the result is reported to both the charging station 510 and the electric vehicle 560.

In both authenticate 1016 and authenticate 1040, the result of the authentication protocol executed in perform 1014 is analyzed by the charging station 510 and the electric vehicle 560 respectively. If the result identifies the electric vehicle 560 as being not authentic, execution for the charging station 510 moves to inform 814 and execution for the electric vehicle 560 moves to inform 644. If the result of the authentication protocol is that the electric vehicle 560 is confirmed as being authentic, then execution for the charging station 510 moves to deliver 622 whereas the execution for the electric vehicle 560 moves to receive 654.

### Additional Example Methods

In another example embodiment of a method, the charging station 510 broadcasts, via a first limited-range transmission in range 518, the charging station identifier 224. The charging station 510 receives, via a second limited-range broadcast in range 562, the vehicle identifier 324 from the electric vehicle 560. The charging station 510 establishes a wireless short-range link with the electric vehicle 560. The charging station 510 receives via the wireless short-range link a financial information from the electric vehicle 560. The charging station 510 delivers, via the cable 512, an amount of energy to the electric vehicle 560 to charging the battery of the electric vehicle 560. In this example method, the charging station 510 may either accept the vehicle identifier 324 has evidence of being registered or the charging station 510 may use the vehicle identifier 324 to verify that the electric vehicle 560 is registered. The charging station 510 may use the financial information to receive payment for charging services.

In another example embodiment of a method, the charging station 510 broadcasts, via a limited-range transmission in the range 518, the charging station identifier 224. Responsive to transmitting, the charging station 510 receives a notice. The notice may include information for establishing a short-range link for communication. The charging station 510 proceeds to establish a wireless short-range link with the electric vehicle 560. The charging station 510 secures the wireless short-range link for secure communication with electric vehicle 560. The charging station 510 and electric vehicle 560 communicate via the secure link information needed for providing and receiving energy. Responsive to the information, the charging station 510 provides an amount of energy to the electric vehicle 560 for charging the battery of the electric vehicle 560.

In another example embodiment of the method, the electric vehicle 560 receives the charging station identifier 224 from the charging station 510. The electric vehicle 560 sends the charging station identifier 224 to the server 580. The server 580 determines the legitimacy of the charging station 510. The electric vehicle 560 receives a notice from the server regarding the legitimacy of the charging station 510. Responsive to the notice identifying that the charging station 510 is legitimate, the electric vehicle 560 establishes a wireless short-range link with the charging station 510. The charging station 510 and electric vehicle 560 communicate via the secure link information needed for providing and receiving energy. Responsive to the information, the electric vehicle 560 receives an amount of energy to the charging station 510 for charging the battery of the electric vehicle 560.

In another example embodiment of a method, the electric vehicle 560 receives the charging station identifier 224 from the charging station 510. The electric vehicle 560 sends the charging station identifier 224 to the server 580. The server determines the legitimacy of the charging station 510. Responsive to the server determining the legitimacy of the charging station 510, the electric vehicle receives the notice from the server 580 regarding the legitimacy of the charging station 510. Responsive to the notice identifying the charging station 510 as legitimate, the electric vehicle establishes a wireless short-range link with the charging station 510 and the electric vehicle 560 receives an amount of energy from the charging station 510 for charging the battery of the electric vehicle 560. Responsive to the notice identifying the charging station 510 as not legitimate, the electric vehicle 560 informs the driver of the electric vehicle 560 to not charge at the charging station 510.

In another example embodiment of a method, electric vehicle 560 requests the charging station identifier 224 from the charging station 510. The electric vehicle 560 receives the charging station identifier 224 from the charging station 510. The electric vehicle 560 sends the charging station identifier 224 to the server 580. The server 580 determines legitimacy of the charging station 510. The electric vehicle 560 receives a notice from the server 580 regarding the legitimacy of the charging station 510. Responsive to the notice identifying the charging station 510 as legitimate, the electric vehicle establishes a wireless short-range link 514 with the charging station 510 and the electric vehicle 560 receives an amount of energy from the charging station 510 for charging the battery of the electric vehicle 560.

### Authentication

Authentication may include single factor authentication, two factor authentication, challenge authentication or any other technique suitable for authenticating the charging station (e.g., 110, 120, 130, 140, 510) to the electric vehicle (e.g., 160, 170, 180, 190, 560), the electric vehicle to the charging station, or mutual authentication. In the example method 1000, information for authentication (e.g., keys and/or authentication data 946, keys and/or authentication data 996) is disclosed as being stored in the database 900. In another example embodiment, the charging station computer 200 stores data (e.g., master encryption key, public encryption keys, identification number) for authentication in its memory 220 and the vehicle computer 300 stores data for authentication in its memory 320. Having the data for authentication stored locally means that the charging station 510 may authenticate the electric vehicle 560, or vice versa, without requesting and/or receiving information from the server 580.

In an example method, the charging station computer 200 and the vehicle computer 300 exchange identifying information (e.g., username, ID) and passwords to perform authentication. In another example method, the charging station computer 200 and the vehicle computer 300 exchange a code generated by a one-time code generator (e.g., Google Authenticator). In another example method, the vehicle computer 300 may be requested to provide its present geographic location as determined by the GPS satellites at the time of the authentication. The geographic location will be an indication as to whether the electric vehicle is proximate to the charging station.

An authentication protocol may include receiving information from an operator (e.g., driver) of the electric vehicle. For example, the driver may provide a username and a password, or a one-time code. The driver may be required to be in possession of a registered cell phone and to provide a code received via the registered cell phone. The operator may be asked to provide biometric information (e.g., fingerprint, iris scan, voice sample, palm print, facial recognition). A registered cell phone may be requested to provide its present geographic location as determined by the GPS satellites at the time of the authentication.

Authentication may include identifying physical characteristics of the charging station and/or the electric vehicle. For example, the charging station 510 may take a picture of the electric vehicle 560. The charging station 510 may send the picture to a server that determines whether the vehicle in the image corresponds to the electric vehicle 560 as registered with the server 580. The electric vehicle 560 may take one or more pictures of the charging station 510 and its surroundings. The electric vehicle 560 may send the one or more pictures of the charging station and its surroundings to the server 580 that determines whether the images correspond to the charging station 510.

### Secure Communications

The communication via the wireless limited-range links 116, 126, 136, 146 and 516, the wireless short-range links 114, 124, 134, 144, 162, 172, 182, 192, 514, 522, and 566, and the wired link 572 may be made secure using any suitable techniques and/or technology. Secure communication makes the data that is transmitted and/or received resistant to tampering such as interception, man-in-the-middle attacks, eavesdropping and relay attacks. Providing secure communications may include encrypting the data sent over the communication links. Any type of encryption and/or encryption key management may be used to secure the communication links.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A method performed by a charging station and an electric vehicle for charging a battery of the electric vehicle, the method comprising:
performed by the charging station:
receiving a vehicle identifier from the electric vehicle;
sending the vehicle identifier to a server for verification;
receiving a vehicle verification notice from the server; and
responsive to the vehicle verification notice identifying the electric vehicle as registered, providing an amount of energy to the electric vehicle for charging the battery of the electric vehicle.
performed by the electric vehicle:
receiving a charging station identifier from the charging station;
sending the charging station identifier to the server for verification;
receiving a charging station verification notice from the server; and
responsive to the charging station verification notice identifying the charging station as registered, receiving the amount of energy from the charging station for charging the battery of the electric vehicle.

2. The method of claim 1, wherein at least one of sending the charging station identifier to the server and sending the vehicle identifier to the server comprises communicating with the server via a long-range link.

3. The method of claim 1, wherein at least one of receiving the charging station identifier from the server and receiving the vehicle identifier from the server comprises communicating with the server via a long-range link.

4. The method of claim 1, wherein responsive to the vehicle verification notice identifying the electric vehicle as registered and the charging station verification notice identifying the charging station as registered, further establishing a wireless short-range link between the charging station and the electric vehicle.

5. The method of claim 4, wherein the electric vehicle transmits a financial information to the charging station via the wireless short-range link.

6. The method of claim 5, wherein the charging station receives the financial information from the electric vehicle via the wireless short-range link.

7. The method of claim 6, wherein the charging station verifies the financial information.

8. The method of claim 1, wherein responsive to the vehicle verification notice identifying the electric vehicle as not registered, transmitting a message to the electric vehicle that service will not be provided.

9. The method of claim 1, wherein responsive to the charging station verification notice identifying the charging station as not registered, presenting a message to a driver of the electric vehicle instructing the driver to not receive services from the charging station.

10. The method of claim 1, further comprising performed by the charging station: requesting the vehicle identifier from the electric vehicle.

11. The method of claim 1, further comprising performed by the electric vehicle: requesting the charging station identifier from the charging station.

12. A method performed by a charging station and an electric vehicle for charging a battery of the electric vehicle, the method comprising:
performed by the charging station:
requesting a vehicle identifier from the electric vehicle;
receiving the vehicle identifier from the electric vehicle;
sending the vehicle identifier to a server for verification;
receiving a vehicle verification notice from the server; and
responsive to the vehicle verification notice identifying the electric vehicle as not registered, transmitting a message to the electric vehicle that service will not be provided; and
responsive to the vehicle verification notice identifying the electric vehicle as registered, providing an amount of energy to the electric vehicle for charging the battery of the electric vehicle;
performed by the electric vehicle:
requesting a charging station identifier from the charging station;
receiving the charging station identifier from the charging station;
sending the charging station identifier to the server for verification;
receiving a charging station verification notice from the server; and
responsive to the charging station verification notice identifying the charging station as not registered, presenting a message to a driver of the electric vehicle instructing the driver to not receive services from the charging station; and
responsive to the charging station verification notice identifying the charging station as registered, receiving the amount of energy from the charging station for charging the battery of the electric vehicle.

13. The method of claim 12, wherein at least one of sending the charging station identifier to the server and sending the vehicle identifier to the server comprises communicating with the server via a long-range link.

14. The method of claim 12, wherein at least one of receiving the charging station identifier from the server and receiving the vehicle identifier from the server comprises communicating with the server via a long-range link.

15. The method of claim 12, wherein responsive to the vehicle verification notice identifying the electric vehicle as registered and the charging station verification notice identifying the charging station as registered, further establishing a wireless short-range link between the charging station and the electric vehicle.

16. The method of claim 15, wherein the electric vehicle transmits a financial information to the charging station via the wireless short-range link.

17. The method of claim 16, wherein the charging station receives the financial information from the electric vehicle via the wireless short-range link.

18. The method of claim 17, wherein the charging station verifies the financial information.

19. A method performed by a charging station and an electric vehicle for charging a battery of the electric vehicle, the method comprising:
performed by the charging station:
receiving a vehicle identifier from the electric vehicle;
sending the vehicle identifier to a server;
responsive sending the vehicle identifier, receiving a first authentication information from the server;
using the first authentication information, authenticating the electric vehicle; and
responsive to determining that the electric vehicle is authentic, providing an amount of energy to the electric vehicle for charging the battery of the electric vehicle;
performed by the electric vehicle:
receiving a charging station identifier from the charging station;
sending the charging station identifier to the server;
responsive sending the charging station identifier, receiving a second authentication information from the server;
using the second authentication information, authenticating the electric vehicle; and
responsive to determining that the charging station is authentic, receiving the amount of energy from the charging station for charging the battery of the electric vehicle.

20. The method of claim 19, further comprising the charging station establishing a wireless short-range link with the electric vehicle.
